(19) United States
(12) Patent Application Publication
(10) Pub. No.: US 2026/0045009 A1
(43) Pub. Date: Feb. 12, 2026

(54) OBJECT-BASED COMPOSITE IMAGE RENDERING USING ALPHA BLENDING

(71) Applicant: Sony Interactive Entertainment LLC, San Mateo, CA (US)

(72) Inventor: Joseph Logan Olson, San Mateo, CA (US)

(21) Appl. No.: 18/797,389

(22) Filed: Aug. 7, 2024

(51) Int. Cl. G06T 11/60

(52) U.S. Cl. CPC G06T 11/60; G06T 2200/24; G06T 2210/62

(57) ABSTRACT

In one aspect, graphic design can be accomplished through generative, object-based composite image rendering. Additionally, alpha transparency can be included in the generative images. Thus, text-to-image models may be used to independently configure the appearance of different graphical objects that are presented in the same graphics space, with primitive base images being used as templates and with the text-to-image model using the templates and a prompt to then generate additional graphical objects with alpha transparency. The generated graphical objects can then act as layers with respect to each other such that they can be independently exported, moved, and further adjusted via additional prompts to the text-to-image model.

### FIELD

The disclosure below relates to technically inventive, non-routine solutions that are necessarily rooted in computer technology and that produce concrete technical improvements. In particular, the disclosure below relates to object-based composite image rendering using alpha blending.

### BACKGROUND

As recognized herein, current generative artificial intelligence (AI) systems leave something to be desired in terms of graphic design. For instance, these systems often re-work an entire generative image responsive to a prompt, even if certain previous aspects were satisfactory. As further recognized herein, many times these systems fail to produce images that are digitally formatted for use in many computer-based graphic design implementations, such as for video game creation that involves the use of complex computer graphics. There are currently no adequate solutions to the foregoing computer-related, technological problem.

### SUMMARY

As also recognized herein, applications like video games sometimes need images that can be decomposed so that individual aspects such as one number or icon can be changed.

Accordingly, in one aspect an apparatus includes at least one processor system configured to render a first graphical object at a first area of a graphical user interface (GUI), with the GUI being presented on a display. The at least one processor system is also configured to receive a text prompt, and to provide the text prompt and the first graphical object as input to a text-to-image model. The at least one processor system is also configured to receive an output, from the text-to-image model, indicating a second graphical object with alpha transparency. The output is based on the text prompt and the first graphical object. The at least one processor system is further configured to render the second graphical object at a second area of the GUI as presented on the display, with the second graphical object being rendered concurrently on the display with the first graphical object.

In some example implementations, the input may be first input, the text prompt may be a first text prompt, and the output may be a first output. According to these examples, the at least one processor system may be further configured to, while the first and second graphical objects are respectively rendered on the GUI at the first and second areas, render a third graphical object at the first area of the GUI. The third graphical object may be movable, within the first area, with respect to the first graphical object. The at least one processor system may also be configured to receive a second text prompt different from the first text prompt. The at least one processor system may be further configured to provide the second text prompt and the third graphical object as second input to the text-to-image model. The at least one processor system may be configured to then receive a second output, from the text-to-image model, indicating a fourth graphical object with alpha transparency. The second output may be different from the first output. The second output may be based on the second text prompt and the third graphical object. The at least one processor system may also be configured to render the fourth graphical object at the second area of the GUI as presented on the display. The fourth graphical object may be rendered concurrently on the display with the first, second, and third graphical objects. In one particular instance, the fourth graphical object may be rendered on the display as an object that is independently movable, in the second area, with respect to the second graphical object. E.g., the fourth graphical object may be independently moveable, in the second area, with respect to the second graphical object by moving the third graphical object in relation to the first graphical object. If desired, user input to move the third graphical object, in the first area, with respect to the first graphical object may thus establish a command to the apparatus to move the fourth graphical object, in the second area, with respect to the second graphical object.

Also in some example implementations, the output may be a generative output establishing the second graphical object. Thus, for example, the second graphical object may be generated by the text-to-image model based on at least one aspect of the appearance of the first graphical object. Also, if desired, the first graphical object may establish strong input to the text-to-image model for the text-to-image model to use the strong input as a basis from which to generate the second graphical object.

Still further, in some example embodiments the at least one processor system may be configured to execute the text-to-image model to provide the output. If desired, the apparatus may even include the text-to-image model.

In various non-limiting examples, the text-to-image model may include a diffusion model and might even be a single diffusion-based text-to-image model that can use images as a secondary input.

Also in various non-limiting examples, the apparatus may include the display.

In another aspect, a method includes rendering, at a first area of a graphical user interface (GUI), a first graphical object and a second graphical object. The first graphical object is movable, within the first area, with respect to the second graphical object. The method also includes receiving a text prompt in relation to one or both of the first graphical object and/or the second graphical object. The method then includes providing the text prompt as input to a model and receiving an output, from the model, indicating a generative image for a third graphical object and/or a fourth graphical object. The method then includes rendering, at a second area of the GUI, the third and fourth graphical objects with one of the third and fourth graphical objects indicating the generative image. The third and fourth graphical objects are rendered concurrently on the GUI with the first and second graphical objects. The third graphical object and the fourth graphical object are separately configurable through different text prompts to the model.

In one example, separately configurable may include separately making appearance changes to the third or fourth graphical object based on different generative images from the model, as generated based on different respective text prompts to the model.

In some instances, the third and fourth graphical objects may be movable, within the second area, with respect to each other. E.g., the third and fourth graphical objects may be movable with respect to each other such that the first graphical object can move while the second graphical object does not concurrently move. Also in certain examples, the third and fourth graphical objects may be movable with respect to each other by respectively moving one of the first and second graphical objects.

Also in certain example implementations, the generative image may include alpha transparency for the third graphical object and/or the fourth graphical object.

In still another aspect, an apparatus includes at least one computer readable storage medium (CRSM) that is not a transitory signal. The at least one CRSM includes instructions executable by a processor system to render, at a first area of a graphical user interface (GUI), a first graphical object. The instructions are also executable to receive a prompt that is related to an alteration to make in relation to the first graphical object. The instructions are further executable to provide the prompt as input to a model, and to provide the first graphical object as input to the model. The instructions are then executable to receive an output, from the model, indicating a generative image with alpha transparency. The generative image is received from the model in response to the input, to the model, of the prompt and the first graphical object. The instructions are also executable to render, at a second area of the GUI, a second graphical object indicating the image with the alpha transparency.

In certain non-limiting instances, the prompt may be a first prompt, the model may include a text-to-image model, and a third graphical object may be separately configurable from the second graphical object through a second prompt to the text-to-image model. The second prompt may be to generate the third graphical object using a fourth graphical object. The first, second, third, and fourth graphical objects may be different from each other. Also according to these examples, the second and third graphical objects may be renderable together in a same area of the GUI as different layers of a composite graphic design.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 shows an example graphical user interface (GUI) that may be presented as part of a graphic design tool consistent with present principles;

FIGS. 3-6 illustrate additional steps in graphic design that may be performed using the GUI and the graphic design tool consistent with present principles;

FIG. 7 shows example logic in example flow chart format that may be executed by a system/apparatus to undertake present principles; and

FIG. 8 shows example artificial intelligence (AI) model architecture that may be implemented consistent with present principles.

### DETAILED DESCRIPTION

The detailed description below provides technical systems and methods for a unique graphic layout/design tool to apply generative imagery to graphic design with fine-grained control, enabling the generating and manipulating of each graphic design element separately as a different layer. Thus, rather than using machine learning (ML) to generate imagery wholesale as a full image with each prompt, present principles allow separate components of a full image to be separately composed and altered using generative ML, providing numerous technical advantages as set forth below. Present principles also avoid the need to edit a whole image after the fact (e.g., replacing the face of a character or altering the background) by using a single “bitmap”. Rather, with present principles, independent layers with transparency may be separately edited. Adding a transparent layer paradigm to the generative imagery tool set forth herein thus allows a graphic designer to independently edit the different components of the final image.

Accordingly, in one implementation an editable layout may use circles and squares with variable stroke/fill. The user can then use different mask options and color choices to help guide the image generation. E.g., different sliders for different graphic design functions may be used to control the text-to-image process (e.g., where one image guides the generated image).

Furthermore, the graphic design tool set forth herein may also have the ability to create and use Boolean shapes (e.g., where one shape subtracts from another) so the tool can do things like guidance shapes with holes in them.

The tool also allows the layers to be moved up, down, left, right etc. with respect to each other. What's more, for background transparency, alpha blending can be included in the model (e.g., using a component such as LayerDiffuse) so the output is natively RGBA. Or in another implementation, the background may be made transparent as a second step on the backend (e.g., using a model such as rembg).

What's more, semantic-based font searching is enabled consistent with present principles so that fonts can be quickly located and then changed even further to create new fonts. To do so, semantic font searching may be done using vector embeddings in a vector database of multimodal embeddings (e.g., text-image embeddings). Images of fonts can then be returned that are most-fitting to the particular search string or search term entered by the user. Thus, in one implementation a database of fonts may be accessed. Each font may then be rendered as an image. A contrastive language-image pretraining (CLIP) model or other text-image embedding model may then be used to generate an embedding vector for each font image and to embed the vector in vector space. The system can then search for fonts by embedding a user's natural language-based search term(s) as another vector in the same vector space to then look for the closest font images in vector space (e.g., through a Cosine Similarity Search). The closest fonts may then be returned to the user as search results, where those results may be the procedurally rendered images that were used to create the font image embeddings in the first place. The tag or other metadata associated with each font image may indicate the associated font itself so that the user can then select one of the results to command the system to use the associated font (as identified in the tag/metadata) as part of a graphic design.

With the foregoing in mind, it is to be understood that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

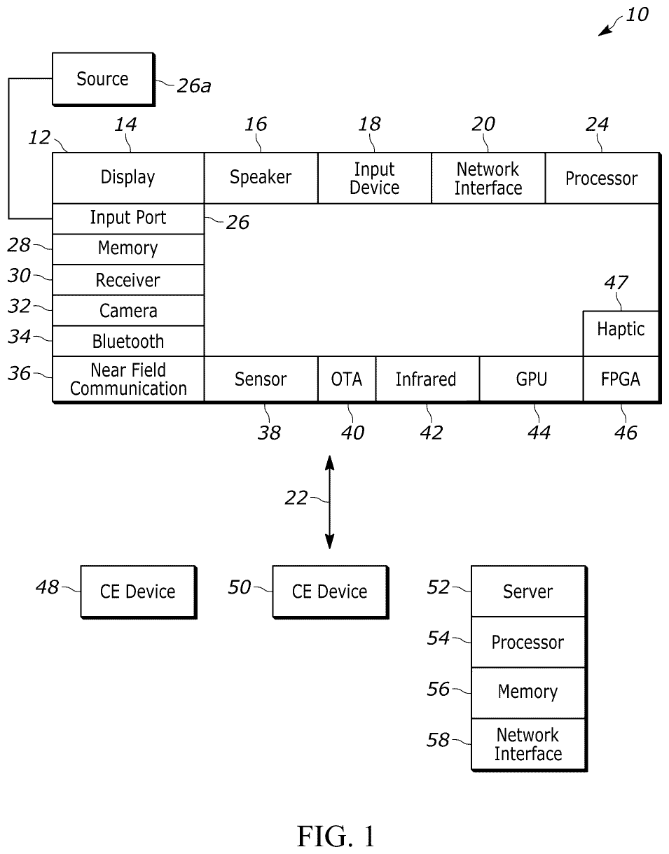

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12 consistent with present principles. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer/video game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player, or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components discussed in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

Also note before describing other figures that selectors and options on the GUIs discussed below may be selected via cursor input, touch input to the touch-enabled display on which the GUI is presented, using voice input, and/or using other input methods.

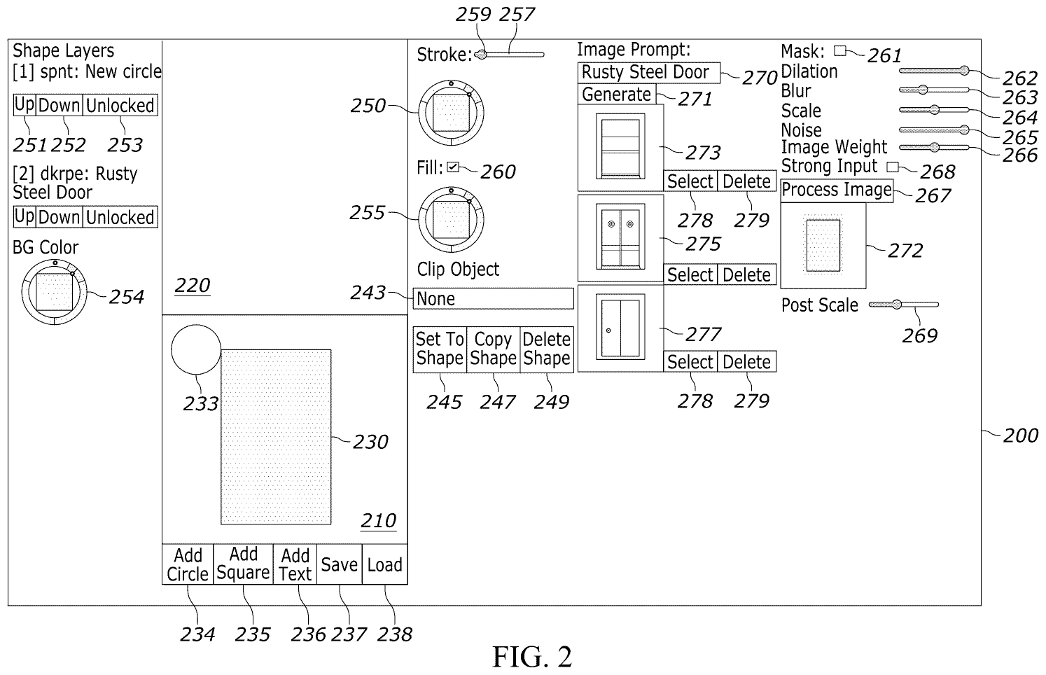

Now in reference to FIG. 2, suppose a video game developer is developing a video game and wants to create some graphics for the game. To do so, the user can launch/open an application (“app”) that is configured to undertake present principles. The app may embody or interface with an artificial intelligence (AI)-based model as discussed in greater detail below. As part of launching the app, the system may present a GUI 200 as shown in FIG. 2.

The GUI 200 may include a first area 210 and a second area 220. Each area 210, 220 may present plural different graphical objects that are separately/independently configurable through different prompts to the AI model. The first area 210 may present primitive objects, such as clip art and adjustable basic shapes like circles, rectangles, and triangles whose size/scale can be adjusted through drag and drops of the respective object's perimeter. The second area 220 may present generative outputs from a text-to-image model as generated using the objects from the first area 210 as templates. Then after rendering in the second area 220, the generative outputs may be scaled by adjusting the size, in the first area 210, of the respective primitive objects on which the generative objects were based. The generative objects may also be moved with respect to each other in the second area 220 by moving a given primitive graphical object with respect to another primitive graphical object in the first area 210, as will be described in greater detail a little later.

Still in reference to FIG. 2, note that here a primitive, rectangular (first) graphical object 230 is presented in the area 210 based on user command. Also note that another primitive, circular graphical object 233 is presented in the area 210 based on user command. Neither primitive object 230, 233 may be presented with alpha transparency, with the respective image files themselves for each object 230, 233 being red green blue (RGB) image files without an alpha channel. Or in other examples, alpha channels may be included in the image files for the primitive objects 230, 233 for even faster processing time by a text-to-image model when outputting a generative RGB-A image file based on the input (primitive) images.

In terms of user commands to present the objects 230, 233 in the area 210, the user may select the “add circle” selector 234 to select an adjustable circle for presentation as the object 233. The user might also select the “add square” selector 235 to select an adjustable square/rectangle for presentation as the object 230. Also note that the GUI 200 may include an “add text selector” 236 that may be selected to add text content as will be described later. The GUI 200 may further include a save selector 237 to save a currently-presented generative composite image rendering (as would be rendered in the area 220), and a load selector 238 to load a previously-saved generative image(s) into the second area 220. In some instances, based on the same single command to select the selector 238, the system may load not just the generative images into area 220 but also the corresponding (and also previously-saved) primitive image(s) into the area 210.

As another example for entering a user command to present a primitive object in the area 210, the user may enter a search term into search box 243 to search clip art. The user may then select a resulting clip art shape that appears beneath the box 243 as a drop-down search result. From there, the user may then select one of the selectors 245-249. The “set to shape” selector 245 may be selectable to insert the selected primitive object into the area 210. The “copy shape” selector 247 may be selectable to copy the selected primitive object to a clipboard. Then once a graphical object in the selected shape is presented in the area 210, the “delete shape” selector 249 may be selectable to delete the respective graphical object from the area 210.

Respective stroke and fill color palettes 250, 255 are also shown on the GUI 200, along with a stroke width scale 257 with a slider 259. The slider 259 may be moved along the scale 257 to adjust stroke width of a graphical object in the selected primitive shape up or down (according to an operative stroke color selected the palette 250). A fill option 260 is also shown and may be selectable to fill the selected primitive object with color according to an operative color selected from the palette 255.

The user may then choose to use the primitive object 230 as a base image for a text-to-image model to then generate a generative image using the primitive object (image) as strong input, with the generative object being presented in the area 220 in the same scale, stroke color, and fill color as the object 230 itself (as controlled via the elements 250-260). However, note that the generative object may have alpha transparency based on the underlying image file output by the model being an RGB-A image file (RGB image file with alpha channel). One example RGB-A image file format that may be used consistent with present principles is a Portable Network Graphics (PNG) file format.

Also shown on the GUI 200 is a front/up selector 251, a back/down selector 252, and a lock/unlock selector 253 for adjusting the draw order of the various layers (objects) to move certain graphical objects in front of, or behind, other rendered graphical objects that overlap each other in the same respective X-Y portions of an area 210/220 when rendered. The selector 251 may therefore be selected to adjust the draw order of a respective graphical object in increments to move the object in front of another graphical object with which it partially or fully overlaps, with the relevant graphical object here being the object 233. The selector 252 may be selected to adjust the draw order of the respective graphical object in increments to move the object behind another graphical object with which it partially or fully overlaps. The selector 253 may be selected to lock the draw order of the respective object at the selected after being adjusted while unlocked, and selected to unlock the draw order of the respective object to further adjust its positioning. As may be appreciated from this figure and subsequent ones, selectors similar to the selectors 251-253 may be presented for each graphical object in the area 220 to adjust individual object transparency for that respective graphical object (and may be presented for each object in the area 210 when the primitive objects in the area 210 are also configured with an alpha channel).

Further note that a background-color color palette 254 may also be presented on the GUI 200 to configure the background color of the area 220 (and hence background color around generative objects shown therein).

Furthermore, if desired, the mask of the primitive object may be altered as part of the strong input. The user may therefore select the mask option 261 to present the selected primitive object (object 230 here) in the preview box 272. Then for each of the different mask adjustment options, the user may move a respective slider back and forth along its respective scale to go up or down on the respective mask effect. As shown in FIG. 2, the mask options themselves may include an image dilation option 262 to dilate the primitive object 230 up/down, an image blur option 263 to blur the primitive object 230 more/less, an image scale option 264 to scale the primitive object 230 up/down, an image noise option 265 to apply more/less noise to the primitive object 230, and an image weight option 266 to apply more/less weight to the primitive object 230. The changes to the mask may be reflected in real time in the preview box 272.

Then once the user has the mask configured as desired, the process image selector 267 may then be selected to apply the different mask effects configured through the options 262-266 to the rendered graphical object 230 as rendered in the area 210. The strong input selector 268 may then be selected to provide the primitive object 230 as altered per the mask options 262-266 as strong input to the text-to-image model. The text-to-image model may then use the strong input as well as a text prompt entered into the box 270 as a basis from which to generate a generative graphical object (e.g., defined in an RGB-A image file generated by the model), as will be described in greater detail in a moment. But also note here that post scale 269 may have its own slider to adjust the post-rendering scale of the object 230 as presented in the area 210.

Now in terms of text prompts to the box 270, the user may use the input box 270 to enter a text-based prompt for the model to generate a generative graphical object using the strong input from above and the prompt itself. Note that the text-based prompt has been labeled as an “image prompt”above the box 270 in FIG. 2.

Once a prompt has been entered into the box 270, the generate selector 271 may then be selected for the system to generate and render plural generative graphical objects 273, 275, 277 on the GUI 200, each of which may have alpha transparency as set forth in an alpha channel for the resulting image file for each object. In the present instance, each object 273-277 is a different generative rusty steel door, based on “rusty steel door” being the image prompt entered into box 270. Next to each object 273-277 may be a respective “select” selector 278 and “delete” selector 279. Each “select” selector 278 may be selectable to command the system to render the respective (adjacent) graphical object 273-277 in the second area 220. The “delete” selector 279 may be selectable to command the system to delete the associated graphical object 273-277 from the area 220 after being rendered in the area 220.

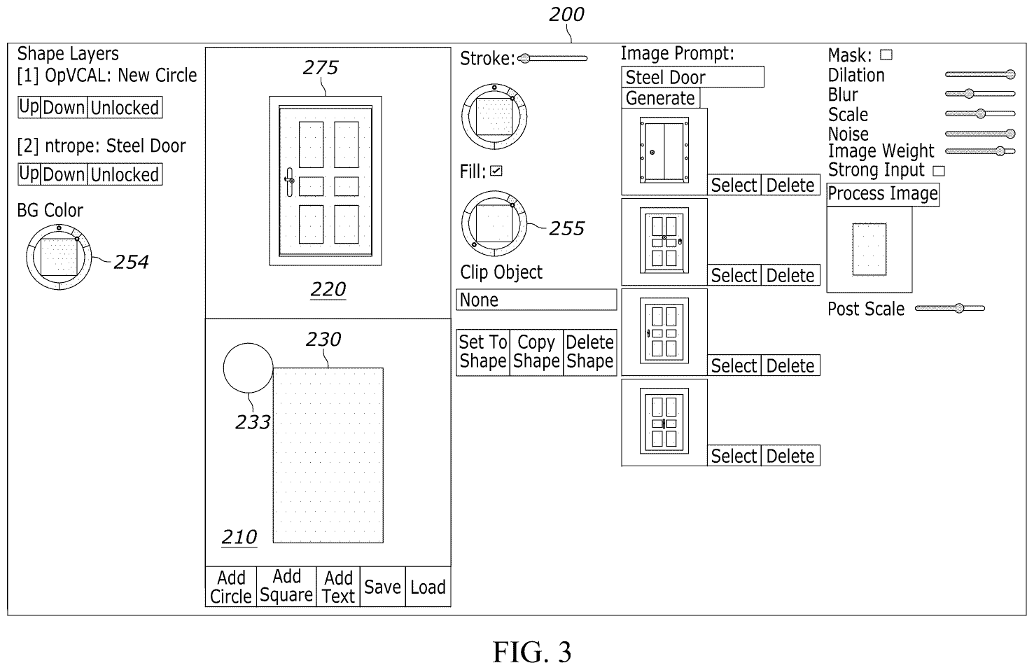

FIG. 3 therefore also shows the GUI 200 with the image controls described above, but with the generative graphical object 275 being selected and therefore rendered in the area 220 with alpha transparency. Note that the door 275 is the same size/scale as the primitive object 230, but is altered from the primitive object 230 itself to visually appear as a rusty steel door using the primitive object 230 as the strong input. Also note per FIG. 3 that the user has used the fill color palette 255 to change the fill color of the object 230 (and hence object 275) from red to blue.

Now suppose the user wants to back out the rusty steel door graphical object 275 and instead use a different generative image. To do so, the user may select the delete selector 279 for the object 275. Additionally or alternatively, the user may select the corresponding primitive object 230 from the area 210 and then select the delete shape selector 249 to delete the primitive object 230, which also acts as a command to delete the object 275 so that it is no longer rendered in the area 220.

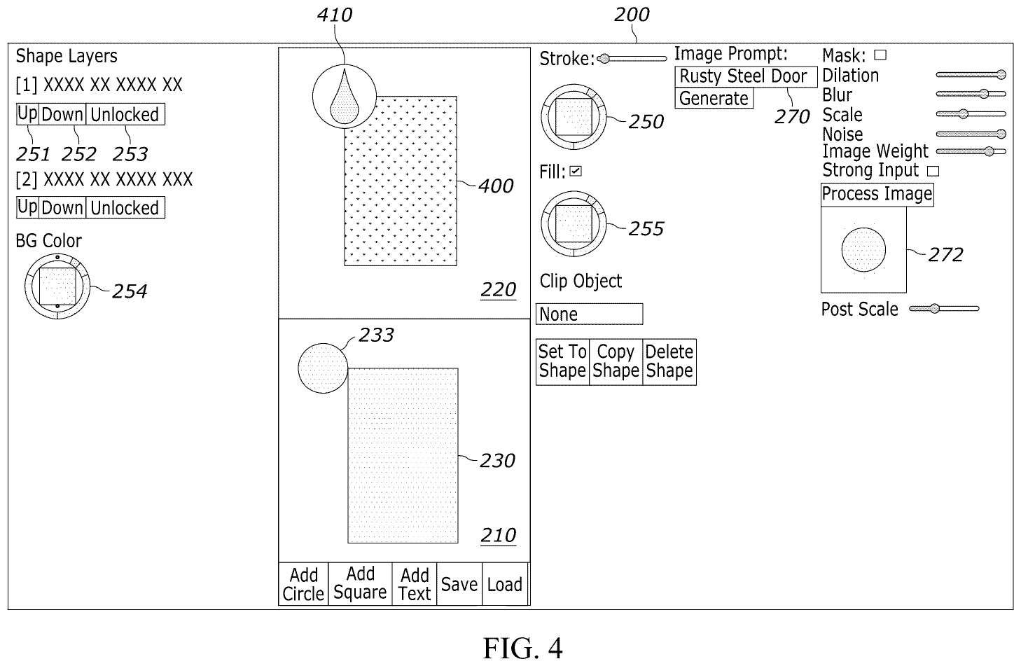

FIG. 4 then demonstrates that the user can go a different direction, using the fill palette 255 to change the color of the object 230 from blue to green. The user may then use the box 270 to provide an image prompt “green shag carpet” for a resulting rendered object 400 (with alpha transparency) to be presented in the area 220 in green color, with the text-to-image model having diffused the object 230 down into a shag carpet generative image using the object 230 as strong input. Thus, by using the object 230 as strong input, the model need not diffuse by starting from pure noise, instead beginning the diffusion process multiple layers into the diffusion process (starting with the image 230 to diffuse from there). This in turn optimizes the model, reducing processing time, saving power, and guiding the model to provide a generative image that is likely to be truer to what the user had in mind than had the model started diffusing from pure noise rather than from the strong input. Lighter text-to-image models with less layers may therefore be realized as a consequence of implementing present principles, with the added advantage of the generative image not drifting too far away from the starting (primitive) image. Again note that the corresponding image file for the object 400 may be an RGB-A image file rather than just an RGB image file with no alpha channel.

Also note per FIG. 4 that the object 233 has now been selected, making the object 233 the operative primitive object for it to therefore be presented in the preview box 272 and adjusted using the options 262-266. The object 233 with adjusted mask may then be used as strong input in relation to another generative object 410 (with alpha channel) that is generated based on the primitive object 233 according to the description above. In the present example, the object 410 is a red blood drop.

FIG. 4 also shows that the object 233 has also been moved over top of the top left corner of the object 230. This may be done through the user selecting the object 233 and then dragging and dropping it over the desired location (top left corner of the object 230) so that the object 233 moves with respect to the object 230 while the object 230 remains stationary within the area 210. This in turn causes the corresponding generative object 410 to also move in the area 220 with respect to the generative object 400 based on the object 233 being moved with respect to the object 230. And note here again that the generative object 410 is a red blood drop based on a generative RGB-A image being output from the text-to-image model, with the output itself being based on all three of (a) red being selected as the fill color for the object 410 via the palette 255, (b) the object 233 being provided as strong input to the text-to-image model, and (c) a text prompt for “blood drop” also being provided to the text-to-image model. The model may thus use all three of those inputs to generate the object 410 (e.g., as encapsulated in an RGB-A image file).

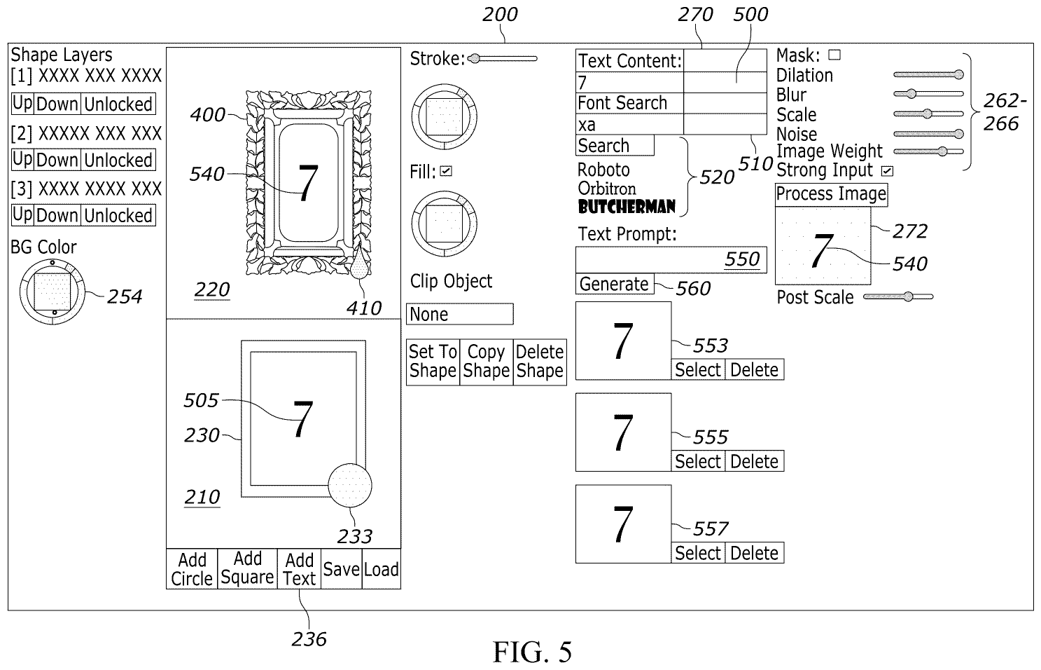

FIG. 5 then shows that the object 400 has now been further altered by the user by providing an additional text prompt to the box 270 to “make the shag carpet in the shape of a picture frame”. The text-to-image model has therefore provided a different generative image to use as the rendered object 400 (still with alpha channel), which in this case is shag carpet in the shape of a picture frame. Also note that the user has moved the object 233 from the top left corner of the object 230 as was shown in FIG. 4 to the bottom right corner of the object 230 as shown in FIG. 5, which acts as a command to similarly move the object 410 from the top left corner of the object 400 to the bottom right corner of the object 410 as also shown in FIG. 5.

Also suppose per FIG. 5 that the user wishes to add text to the composite generative image/objects being rendered in the area 220. To do so, the user may select the add text selector 236 to add text content (also with alpha transparency) for inclusion in the composite generative image/objects. Selection of the selector 236 may therefore cause a text content input box 500 to be dynamically presented on the GUI 200 so that the content of the text may be specified by entering desired text into the box 500. In the current example, the user has entered the number “7” into the box 500, which in turn causes primitive text 505 corresponding to the number seven to be presented in the area 210 in a default font style.

The user may then semantically search for a desired font for the text entered into box 500 by entering natural language into the font search box 510, which in turn causes predetermined, separately selectable fonts 520 to be presented as drop-down search results. The results themselves may be presented based on semantic-based font searching in vector space according to the description above. Then once a font has been selected from the search results 520, text appearance per the selected font may be altered even further based on an image prompt to input box 550. Accordingly, options 553, 555, and 557 may be presented as selectable options responsive to this prompt, with the generative object shown for each option 553-557 being generated by the text-to-image model using, as input to the model, (a) the font 520 selected by the user and (b) the text content entered into box 500, both as strong input, along with (c) additional natural language text as input to the box 550 for how to change the appearance of the text entered into box 500 even further. The model may then use those inputs to generate the different generative object options 553-557 as RGB-A image files, each corresponding to a different generative image-based text object having alpha transparency. Therefore, like other graphical objects generated by the model as set forth herein, the model may output RGB-A image files for the user's text so that the text content has alpha transparency. Also note for completeness that generate selector 560 may be selected to actually generate, based on the strong inputs related to the text content, the graphical objects to present as the options 553-557.

One of the options 553-557 as presented on the GUI 200 may then be selected by the user, which in this case is the option 557. This in turn causes the corresponding generative graphical object 540 to be presented in preview box 272 for further adjustments via the options 262-266. Additionally or alternatively, the option 557 may be selected to command the generative object 540 to be rendered in the area 220 with respect to the other generative objects 400, 410 at the same corresponding position in the area 220 as the primitive object 505 is presented in the area 210 with respect to the other primitive objects 230, 233.

Additionally, note that should the user wish to use additional text that is stylistically the same as/similar to the generative object 540, using the selected font itself would not suffice since that font was further altered via the text-to-image model. Therefore, a tool like IP-Adapter may be used to make one piece of generative text (e.g., the number “5”) look like another piece of generative text the user already generated and likes (e.g., the number “7” as shown). This allows the user to create new fonts from scratch, with alpha channels for each character.

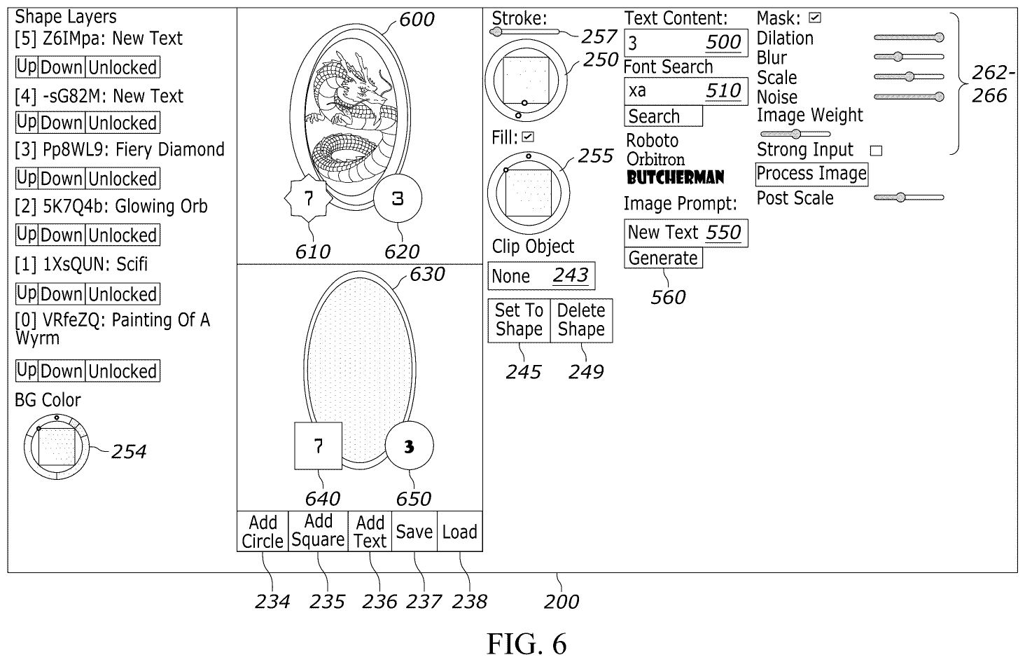

FIG. 6 shows another example consistent with present principles. Here, the GUI 200 has been used to render complex generative objects 600, 610, 620 with alpha transparency in the area 220, as generated in part using respective primitive objects 630, 640, 650 as shown rendered in the area 210. This figure therefore demonstrates that text content may be included as part of any of the image-based generative objects mentioned herein, with numerical text being presented for the objects 610, 620. Further note that Boolean shapes may also be used for one shape to subtract from another similar to how the numbers are inset in the objects 610, 620.

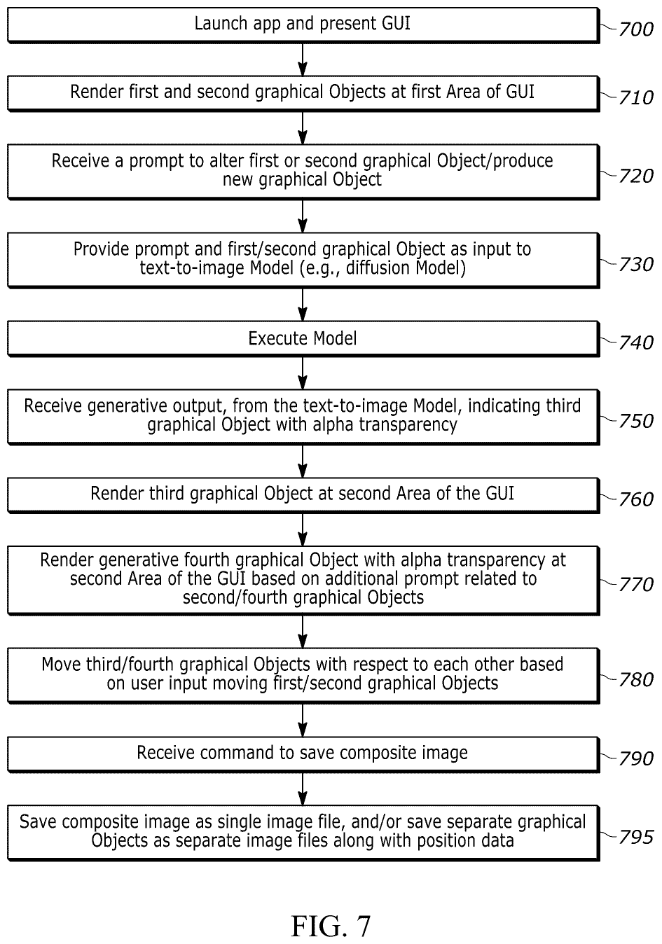

Now in reference to FIG. 7, this figure shows example logic that may be executed by an apparatus such as the CE device 12, a client device, and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Further note that while the logic of FIG. 7 is shown in flow chart format, other suitable logic may also be used.

Beginning at block 700, the apparatus may launch a graphic design app configured to undertake present principles, such as responsive to user command to launch the app. Also at block 700, the apparatus may present a graphic design GUI like the GUI 200 described above. From block 700 the logic may proceed to block 710.

At block 710 the apparatus may render, at a first area of the GUI, a first graphical object and a second graphical object. For example, at block 710 the logic may render first and second primitive graphical objects in a GUI area like the area 210. In non-limiting examples, the primitive graphical objects may be sourced from respective RGB image files lacking alpha channels. From block 710 the logic may then proceed to block 720.

At block 720 the apparatus may receive a first prompt related to an alteration to make in relation to the first graphical object or in relation to the second graphical object. For this example, assume the first prompt is to generate a generative graphical object based on the first graphical object in particular. The first prompt may therefore include a text command for a model operating consistent with present principles to generate a new, generative graphical object using the prompt as input (as well as the first object itself as input). As another example, the prompt may be to further change an already-output and rendered generative graphical object. In either case, at block 730 the apparatus may actually provide the first prompt received at block 720 as input to the model along with the additional (strong) input in the form of the first graphical objects itself.

Before moving on, note here that the model may be or include a text-to-image model consistent with present principles. In one particular instance, the text-to-image model may be a diffusion model, such as a latent diffusion model or stable diffusion model. As a specific example, SDXL Turbo may be used. Other types of text-to-image models may also be used, including generative adversarial networks, transformers, and variational auto encoders.

Still in reference to FIG. 7, the logic may proceed from block 730 to block 740 where the apparatus may execute the model to, at block 750 in response to the prompt, receive a generative output from the model. The generative output may indicate a generative image with alpha transparency (e.g., in the form of an RGB-A image file) to use as a third graphical object corresponding to the first graphical object. From block 750 the logic may then proceed to block 760 where the third graphical object may be rendered at a second area of the GUI, such as the area 220 of the GUI 200. Thus, the third graphical object may exhibit the alteration to the first graphical object as related to at least one aspect of the visual appearance of the first graphical object.

The logic may then proceed to block 770. At block 770 the apparatus may render a generative fourth graphical object with alpha transparency at the second area of the GUI as well. Note that the fourth graphical object may therefore be generated and rendered at block 770 via the process already described above in reference to blocks 720-750, but using a second text prompt as input as well as additional (strong) input in the form of the second graphical object. Thus, at this point each of the first, second, third, and fourth graphical objects may be concurrently rendered on the user's display. Also note that additional primitive and generative graphical objects may also be rendered consistent with this description, and that only two objects for each area are being described as an example.

After block 770 the logic may then move to block 780. At block 780 the apparatus may move the third or fourth graphical objects in the second area with respect to each other based on/in response to respective user input to move the first or second graphical object in the first area. Thus, the generative third graphical object may be independently moveable, in the second area, with respect to the generative fourth graphical object (e.g., third graphical object may move while the fourth graphical object stays stationary and does not move concurrent with movement of the third graphical object).

In one specific example, the third graphical object may be movable not by directing cursor or other user input over any part of the second area itself (where the third graphical object is presented), but rather by directing input over the first area to select the first (primitive) graphical object that corresponds to the third graphical object to then move the first graphical object in relation to the second graphical object, which in turn moves the third graphical object in relation to the fourth graphical object. Thus, the first graphical object may be selected, dragged, and dropped from a first location in the first area to a second location in the first area, moving the third graphical object from a third location in the second area to a fourth location in the second area through the same command.

Likewise, the fourth graphical object may be movable not by directing cursor or other user input over any part of the second area itself, but rather directing input over the first area to select the second (primitive) graphical object that corresponds to the fourth graphical object to then move the second graphical object in relation to the first graphical object, which in turn moves the fourth graphical object in relation to the third graphical object. Thus, the second graphical object may be selected, dragged, and dropped from a fifth location in the first area to a sixth location in the first area, moving the fourth graphical object from a seventh location in the second area to an eighth location in the second area.

However, further note that in addition to or in lieu of the foregoing, the third and fourth (generative) graphical objects may be moveable by directing user input over the second area itself to independently select, drag, and then drop the third and fourth graphical objects themselves within the second area. This in turn may cause corresponding movement of the primitive first and second graphical objects in the first area as well.

From block 780 the logic may then proceed to block 790. At block 790 the apparatus may receive a command to save the individual generative images rendered in the second area as separate RGB-A image files. Additionally or alternatively, at block 790 the apparatus may receive a command to save the composite image (that combines the individual generative images) as a single RGB-A image file. For example, the save selector 237 may be selected from the GUI 200 as described above to provide the save command(s) received at block 790.

Responsive to the save command(s), the logic may then proceed to block 795 where the apparatus may actually save the composite image as a single image file with an alpha channel for alpha transparency (RGB-A file), with the composite image including all of the generative images currently shown in the second area so that their positional data with respect to each other is encapsulated in the single image file itself. In addition to or in lieu of that, at block 795 the apparatus may save each separately-rendered generative graphical object that is currently presented in the second area as a separate single image file with alpha channel for alpha transparency, allowing independent export and uses of each generative object.

In embodiments where separate image files are saved for each generative graphical object, in some examples position metadata may also be generated and attached to that image file to indicate the respective graphical object's positional relationship to the other generative graphical objects in the second area. This allows the system to recompose the composite image after the fact using the separate image files for each generative graphical object. At the same time, saving the generative graphical objects as separate image files also allows each graphical object to be reused, exported, and applied to other graphic designs as desired. This allows for the quick design of related by not identical graphic designs (e.g., in a same theme) while also eliminating additional processing that would otherwise be required to separate a graphical object out of a composite image after the fact.

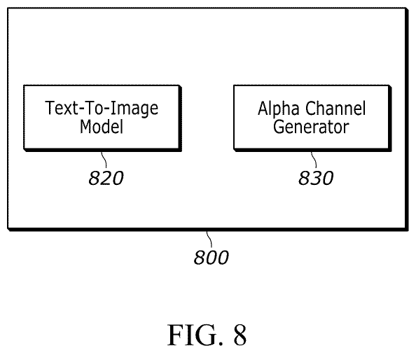

Continuing the detailed description in reference to FIG. 8, this figure shows example AI model architecture that may be implemented consistent with present principles. Thus, an overall AI model 800 may include a text-to-image model 820, such as SDXL Turbo or another suitable (optionally single) text-to-image generator. More generally, the text-to-image model may be a diffusion model such as a latent or stable diffusion model, and/or another type of text-to-image model such as a generative adversarial network (GAN), transformer, and/or variational auto encoder. The text-to-image model 820 may therefore take, as input, the user's text prompt as well as the strong input of a primitive graphical object as set forth above to help guide the model 820 according to the text prompt.

The AI model 800 may also include an alpha channel generator 830. However, in some examples, the alpha channel generator 830 may not be included in the overall model 800 for embodiments where the text-to-image model 820 itself supports transparency to output RGB-A images (with alpha channel) natively as generative outputs from the model 820 itself.

However, in other examples, the model 820 may generate RGB images without an alpha channel, and so here the alpha channel generator 830 may be a separate component of the overall model 800 to generate an alpha channel based on the RGB image from the text-to-image model 820. According to this implementation, the generator 830 may be a background removal tool such as Rembg, for example.

Thus, in one example the text-to-image model may receive a text-based prompt as input as well as receive a primitive object (with masking alterations) as secondary input. The text-to-image model 820 may then generate a native image file as an RGB-A file and provide that as the output from the model 800. Or the text-to-image model 820 may generate a native image file as an RGB file without alpha channel, which may then be provided as input to the (separate) alpha channel generator 830 for the generator 830 to generate an alpha channel for the native RGB image (and provide an output in the form of an RGB-A image).

Note that each of the elements 820 and 830 of the model 800 may be distributed across one or more than one remotely-located server that is communicating with a client device used by the end user (e.g., to present the GUI 200 as described above).

It may now be appreciated that present principles provide apparatuses and methods for object-based composite image rendering using alpha blending, advantageously enabling piecemeal image-to-image rendering of different graphical objects with alpha transparency to do montage graphic design. Strong inputs may be used to reduce model processing time and even to use lighter models with less layers (e.g., diffusion layers) while staying truer to the spirit of the user's initial text prompt.

The resulting generative graphical objects may also be provided with alpha transparency for use, reuse, and export in a variety of different graphic design contexts, either with the other generative graphical objects or apart from them due to the composite nature of the image rendering and individual RGB-A image files. In terms of video game schema development in particular, present principles enable fast, reduced-processing design of different visual game elements such as icons and game objects. The game elements can then be used, reused, and modified as different game assets, avoiding decomposition of a complex single image asset after the fact, which can be processing intensive and time intensive.

While the particular embodiments are herein shown and described in detail, it is to be understood that the subject matter which is encompassed by the present application is limited only by the claims.

What is claimed is:

1. An apparatus, comprising:
at least one processor system configured to:
render a first graphical object at a first area of a graphical user interface (GUI), the GUI presented on a display;
receive a text prompt;
provide the text prompt and the first graphical object as input to a text-to-image model;
receive an output, from the text-to-image model, indicating a second graphical object with alpha transparency, the output being based on the text prompt and the first graphical object;
render the second graphical object at a second area of the GUI as presented on the display, the second graphical object being rendered concurrently on the display with the first graphical object.

2. The apparatus of claim 1, wherein the input is first input, wherein the text prompt is a first text prompt, wherein the output is a first output, and wherein the at least one processor system is configured to:
while the first and second graphical objects are respectively rendered on the GUI at the first and second areas, render a third graphical object at the first area of the GUI, the third graphical object being movable, within the first area, with respect to the first graphical object;
receive a second text prompt different from the first text prompt;
provide the second text prompt and the third graphical object as second input to the text-to-image model;
receive a second output, from the text-to-image model, indicating a fourth graphical object with alpha transparency, the second output being different from the first output, the second output being based on the second text prompt and the third graphical object;
render the fourth graphical object at the second area of the GUI as presented on the display, the fourth graphical object being rendered concurrently on the display with the first, second, and third graphical objects.

3. The apparatus of claim 2, wherein the fourth graphical object is rendered on the display as an object that is independently movable, in the second area, with respect to the second graphical object.

4. The apparatus of claim 3, wherein the fourth graphical object is independently moveable, in the second area, with respect to the second graphical object by moving the third graphical object in relation to the first graphical object.

5. The apparatus of claim 4, wherein user input to move the third graphical object, in the first area, with respect to the first graphical object establishes a command to the apparatus to move the fourth graphical object, in the second area, with respect to the second graphical object.

6. The apparatus of claim 1, wherein the output is a generative output establishing the second graphical object.

7. The apparatus of claim 6, wherein the second graphical object is generated by the text-to-image model based on at least one aspect of the appearance of the first graphical object.

8. The apparatus of claim 6, wherein the first graphical object establishes strong input to the text-to-image model for the text-to-image model to use the strong input as a basis from which to generate the second graphical object.

9. The apparatus of claim 1, wherein the at least one processor system is configured to:
execute the text-to-image model to provide the output.

10. The apparatus of claim 9, comprising the text-to-image model.

11. The apparatus of claim 1, wherein the text-to-image model comprises a diffusion model.

12. The apparatus of claim 1, comprising the display.

13. A method, comprising:
rendering, at a first area of a graphical user interface (GUI), a first graphical object and a second graphical object, the first graphical object being movable, within the first area, with respect to the second graphical object;
receiving a text prompt in relation to one or more of: the first graphical object, the second graphical object;
providing the text prompt as input to a model;
receiving an output, from the model, indicating a generative image for one or more of: a third graphical object, a fourth graphical object;
rendering, at a second area of the GUI, the third and fourth graphical objects with one of the third and fourth graphical objects indicating the generative image, the third and fourth graphical objects being rendered concurrently on the GUI with the first and second graphical objects, the third graphical object and the fourth graphical object being separately configurable through different text prompts to the model.

14. The method of claim 13, wherein separately configurable comprises separately making appearance changes to the third or fourth graphical object based on different generative images from the model as generated based on different respective text prompts to the model.

15. The method of claim 13, wherein the third and fourth graphical objects are movable, within the second area, with respect to each other.

16. The method of claim 15, wherein the third and fourth graphical objects are movable with respect to each other such that the first graphical object can move while the second graphical object does not concurrently move.

17. The method of claim 15, wherein the third and fourth graphical objects are movable with respect to each other by respectively moving one of the first and second graphical objects.

18. The method of claim 13, wherein the generative image comprises alpha transparency for one or more of: the third graphical object, the fourth graphical object.

19. An apparatus, comprising:
at least one computer readable storage medium (CRSM) that is not a transitory signal, the at least one CRSM comprising instructions executable by a processor system to:
render, at a first area of a graphical user interface (GUI), a first graphical object;
receive a prompt, the prompt related to an alteration to make in relation to the first graphical object;
provide the prompt as input to a model and provide the first graphical object as input to the model;
receive an output, from the model, indicating a generative image with alpha transparency, the generative image received from the model in response to the input, to the model, of the prompt and the first graphical object;
render, at a second area of the GUI, a second graphical object indicating the image with the alpha transparency.

20. The apparatus of claim 19, wherein the prompt is a first prompt, wherein the model comprises a text-to-image model, and wherein a third graphical object is separately configurable from the second graphical object through a second prompt to the text-to-image model, the second prompt being to generate the third graphical object using a fourth graphical object, the first, second, third, and fourth graphical objects being different from each other, the second and third graphical objects being renderable together in a same area of the GUI as different layers of a composite graphic design.
